(19) United States
(12) Patent Application Publication
(10) Pub. No.: US 2007/0079706 A1
(43) Pub. Date: Apr. 12, 2007

(54) Control gas filter for gas processing system

(76) Inventors: Richard W. Richey, Chico, TX (US); Michael K. Richey, Chico, TX (US)

Correspondence Address: James E. Bradley, P.O. Box 61389, Houston, TX, 77208-1389, US

(21) Appl. No.: 11/248,624

(22) Filed: Oct. 12, 2005

(51) Int. Cl. B01D 46/00

(52) U.S. Cl. 96/408

(57) ABSTRACT

A control gas system for a well gas separator uses a filter to further remove liquid from the control gas. The control gas flows through a gas line to a drain valve actuator to cause the actuator valve to open. A float valve located in the control gas line will supply gas from the separator to the control gas line to allow flow out the drain valve when the float senses that the liquid level has risen sufficiently. The filter is a tubular member having a mesh material within it. The inlet end is located below the outlet so that moisture collected therein flows back down an entry portion of the control gas line.

### BACKGROUND OF THE INVENTION

Gas wells typically produce liquid along with the gas. The liquid could be either hydrocarbon condensate, water, or a combination of both. A separator is typically located near the wellhead for separating liquid from the gas before the gas proceeds to a gas pipeline. The separators may be of variety types including gravity separators or those that separate in response to centrifugal force imparted to the mixture flowing through the separator.

A typical separator will have an area where liquid accumulates and is periodically drained. The liquid accumulates within a portion of the separator that is at the pressure of the flowing gas. This portion of the separator has a drain with a drain valve. Opening the drain valve causes the liquid to flow out the drain due to the pressure in the separator as well as gravity. After the liquid drains down to selected level, the drain valve must closed, otherwise gas will flow out the drain rather than to the pipeline.

One type of automatic drain control system is illustrated in FIG. 1. Separator 11 has a gas liquid inlet and a main gas flow outlet. Separator 11 also has a drain valve 13 that is used to drain collected liquid from separator 11. Drain valve 13 has an actuator 15 that causes drain valve 13 to open upon receipt of control gas pressure. Actuator 15 receives control gas pressure from a control gas line 17. Control gas line 17 leads from separator 11 or from the main outlet line leading from separator 11. A pressure regulator 19 located in control gas line 17 reduces the pressure of control gas line 17 to a selected level, such as about 30 psi. A float valve 21 is connected into control gas line 17 for opening and closing control gas line 17. Float valve 21 has a float that detects the level of liquid in separator 11. When the level reaches a selected amount, float valve 21 opens, releasing control gas 17 to flow to actuator 15 to open valve 13. When the liquid level drops to a lower selected level, float valve 21 closes and springs within actuator 15 cause drain valve 13 to close.

A problem with the system illustrated in FIG. 1 is that the control gas may still have an appreciable quantity of moisture, even though it comes from the main outlet line or a portion of separator 11 downstream from the separating components. This moisture, or minerals within the moisture, may cause corrosion or clogging of the various components in the control gas line, such as the float valve and actuator. Sometimes liquid chemicals are injected into gas wells, and some of the chemicals can return up the well, pass through the separator, and enter the control gas line. These chemicals can also be detrimental to the control system.

Some gas wells also have control systems that sense excess pressure at the separator outlet and close a valve leading to the separator if such occurs. These control systems utilize valve actuators that are driven by gas pressure and thus may also experience problems due to liquid in the gas stream downstream of the separator.

Some prior art systems utilize an additional control gas separator for separating any liquid downstream of the main separator. Typically these control gas separators rely on gravity separation. While that separation may help, improvements are still needed.

### SUMMARY OF THE INVENTION

In this invention, a filter is placed in the control gas line, preferably upstream of the pressure regulator. The filter has a mesh filter element that is oriented so that the upstream end is lower end than the downstream end. Moisture trapped by the filter thus flows back into the upstream portion of the control gas line.

In the preferred embodiment, the filter has a tubular housing with transverse plates spaced apart from each other. The mesh filter material is located between these plates. Each plate has at least one aperture for the passage of the control gas. Preferably the filter material comprises a rolled up strip of mesh material.

### BRIEF DESCRIPTION OF THE DRAWINGS

FIG. 1 is a schematic illustration of a prior art control system for a gas separator.

FIG. 2 is a sectional view of a control gas filter.

FIG. 3 is a sectional view of the control gas filter of FIG. 2, taken along the line 3-3 of FIG. 2.

FIG. 4 is a schematic view of the filter of FIG. 2 installed in a control system for a gas separator.

FIG. 5 is a schematic view of the filter of FIG. 2 installed in another type of gas control system for a gas separator.

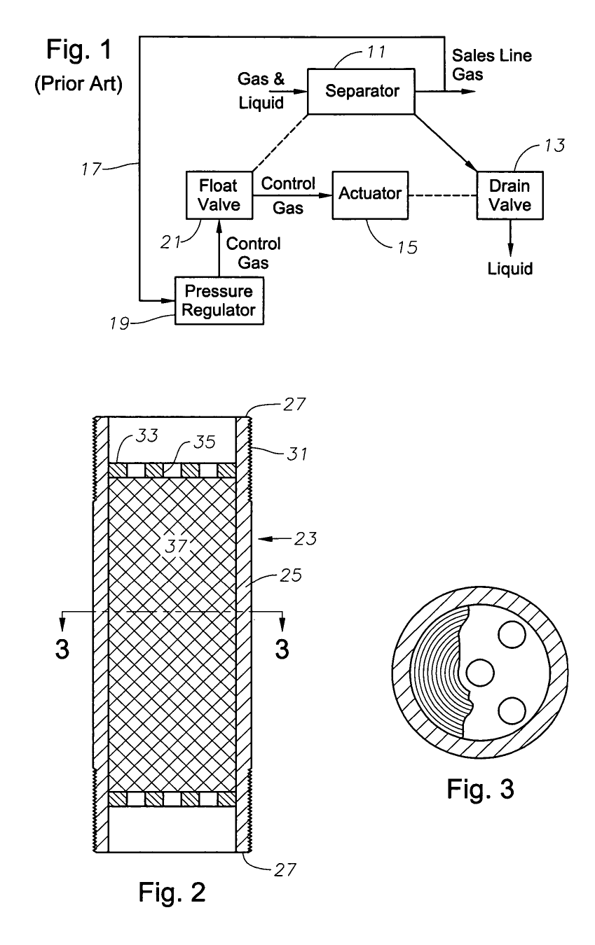

### DETAILED DESCRIPTION OF THE INVENTION

Referring to FIG. 2, filter 23 has a tubular housing 25, which preferably comprises a steel pipe. Housing 25 has a vertical axis and constant inner and outer diameters in this embodiment. Housing 25 has a downstream end 27 on the upper end and an upstream end 29 on the lower end. Outlet 27 and inlet 29 have the same diameters as the inner diameter of housing 25 and have threads 31 on the exterior.

A pair of plates 33 is secured in housing 25 perpendicular to an axis of housing 25. Each plate 33 is located near one of the ends 27, 29. Plates 33 are welded to housing 25 in this embodiment but could be secured in other manners. Plates 33 have at least one, and preferably a plurality of apertures 35 through them to allow gas to flow through.

A mesh filter 37 is located between plates 33. Mesh filter 37 is preferably of a stainless steel woven mesh material. In this embodiment, mesh filter 37 comprises a single strip of mesh material rolled tightly about the axis of housing 25 in a spiral, as schematically illustrated in FIG. 3. The width of the strip of mesh material equals the distance between plates 33.

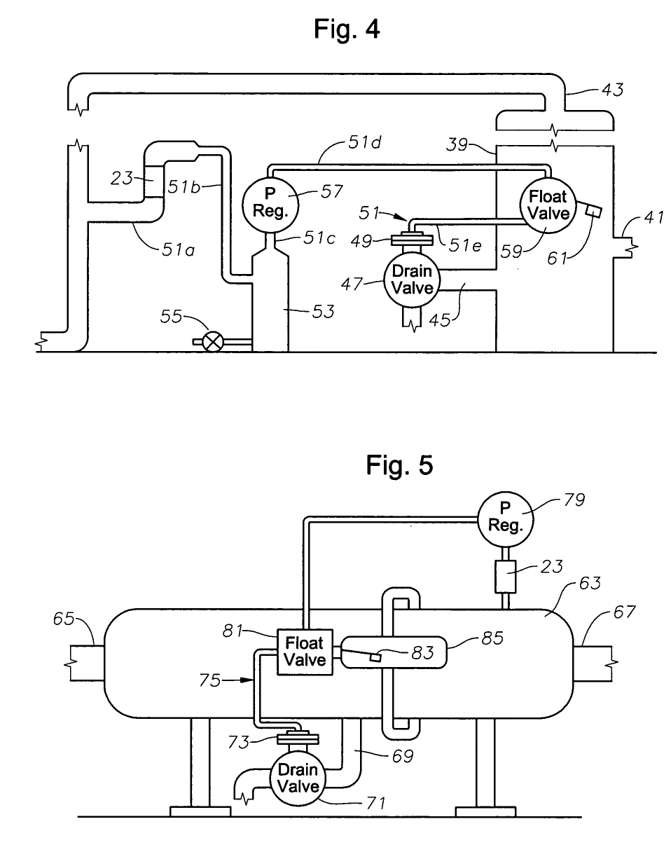

Filter 23 may be utilized in a variety of gas separation systems. In the embodiment of FIG. 4, primary gas separator 39 is a vertical gravity type separator. Separator 39 is a large cylindrical member with a vertical axis. Separator 39 has a main flow inlet 41, which receives a mixture of liquid and gas, and is located on its sidewall. The gas flows upward to a main outlet line 43. The upward flow causes liquid within the gas stream to separate by gravity and accumulate in the bottom of separator 39. Typically, a mesh filter is located in the upper end of separator 39 to further assist in removing liquid from the gas stream. Mesh material 37 (FIG. 2) of control gas line filter 23 may be of the same type as used in primary separator 39.

Separator 39 has a drain outlet 45 located near its lower end. Drain outlet 45, when open, allows liquid to flow out separator 39. The liquid accumulating in the bottom of separator 39 will be at the pressure of the gas within chamber 39, which is substantially the same pressure in main outlet line 43.

A drain valve 47 opens drain outlet 45 when the liquid level reaches a selected level within separator 39. Drain valve 47 is pressure-activated by an actuator 49. Actuator 49 will open drain valve 47 when it receives gas pressure from a control gas line 51. Control gas line 51 has a number of segments and extends from either the upper end of separator 39 or from the main outlet line 43. Preferably, control gas line 51 leads from a place in the gas flow path that is downstream of where the separation occurs within primary separator 39.

In this embodiment, control line segment 51a extends in a T-junction from a vertical portion of main outlet line 43. Segment 51a preferably extends either horizontally or tilts upwardly to a connection with filter 23. In this embodiment, segment 51a is a pipe with the same diameter as housing 25 of filter 23, but it could differ. Filter 23 is oriented vertically, parallel with a portion of main outlet line 43 in this embodiment. Filter inlet 29 is located above control line portion 51a and filter outlet 27 is above inlet 29.

Control line 51 has a second segment 51b that undergoes a reduction in diameter and in this embodiment, leads to an optional control gas separator 53. Control gas separator 53 is a small gravity separator similar to separator 39. If any liquid was present in the control gas at control gas separator 53, some of it will drop out and accumulate in the lower portion of control gas separator 53. A manual valve 55 is periodically opened by a worker to drain any liquid from control gas separator 53.

Control line 51 has a third segment 51c that leads from control gas separator 53 to a pressure regulator 57. Pressure regulator 57 drops the pressure in first and second segments 51a, 51b from the gas pressure in main outlet line 43 to a lower level, such as about 30 psi. A fourth segment 51d leads from pressure regulator 57 to a float valve 59. Fourth segment 51d may be of even smaller diameter than second and third segments 51b, 51c. Float valve 59 is a conventional member that mounts to the sidewall of separator 39. Float valve 59 has a sensor, which in this embodiment comprises a float 61 located within the interior of separator 39. When float 61 rises to a selected level, float valve 59 will open, allowing gas pressure from fourth segment 51d to flow to a fifth control gas line segment 51e. Fifth segment 51e is normally of the same diameter as fourth segment 51d and leads to actuator 49.

In the operation of the embodiment of FIG. 4, a mixture of gas and liquid flows into main inlet 41. Gas separates from the liquid and flows out main outlet line 43 while liquid accumulates in the lower portion of separator 39. When float 61 senses a selected level, it will cause float valve 59 to open. Gas from the main outlet line 43 will flow through control gas line 51a into filter 23. Filter 23 separates residual liquid from the gas. The liquid drains back into control line segment 51a and into main outlet line 43. The gas flows through control gas line separator 53, if one is employed, and pressure regulator 57. Pressure regulator 57 drops the pressure of the control gas, which then flows through float valve 59 to actuator 49. Actuator 49 opens drain valve 47, allowing the liquid in separator 39 to flow out drain 45. When float 61 reaches a selected lower position, valve 59 closes, cutting off the supply of control gas to actuator 49. Springs within actuator 49 cause drain valve 47 to close.

In the embodiment of FIG. 5, separator 63 is of a horizontal type having an inlet 65 on one end and an outlet 67 on the other end. Separator 63 may be of a variety of types, including types that utilize devices within to cause separation due to centrifugal force. Separator 63 accumulates liquid and has a drain 69 in its lower side. Drain valve 71 is of an automatic type, actuated by actuator 73 when actuator 73 receives control gas pressure. A control gas line 75 in this embodiment leads from the upper side of gas separator 63 near outlet 67. However, control gas line 75 could also be connected directly into the main outlet line leading from outlet 67.

In this embodiment, filter 23 is mounted vertically above separator 63 so that any accumulated liquid will drain from filter 23 back into separator 63. Pressure regulator 79 is mounted to the upper end of filter 23. In this example, there is no control gas line separator similar to separator 53 (FIG. 4). Pressure regulator 79 reduces the pressure to a control gas level as it flows to a conventional float valve 81. In this example, float valve 81 has a float 83 located within an exterior liquid level chamber 85. Liquid level chamber 85 is located on the exterior of separator 63 and is connected into separator 63 at upper and lower sides.

When liquid within separator 63 reaches a selected level, it will enter liquid level chamber 85 and cause float 83 to begin to float upward. When float 83 floats sufficiently high, it will open float valve 81 to provide control gas pressure to actuator 73. Actuator 73 will then open drain valve 71 to allow liquid to drain from drain 69 until float valve 83 drops to a selected lower level. At that point, float valve 81 cuts off the control gas flow, and actuator 73 returns drain valve 71 to the closed position by means of a spring. As the gas flows through control line 75, filter 23 will further separate liquid from the control gas. The liquid will drain back down into separator 63.

The invention has significant advantages. The use of a filter in the control line further separates moisture in the control gas to prevent corrosion of the float valve and actuator. By mounting the filter vertically with its inlet lower than the outlet, the accumulated liquid drains into the main gas system. The control gas filter reduces the chances for the drain valve to stick open, which would result in excessive gas being lost out the drain line.

While the invention has been shown in only two of its forms, it should be apparent to those skilled in the art that it is not so limited but is susceptible to various changes without departing from the scope of the invention. For example, the filter could be located in a control system for sensing excess pressure and closing a valve leading to the separator.

1. A control system for a gas/liquid separator having a first port for receiving a liquid/gas mixture, the gas separator having a second port for the outflow of separated gas and a third port for the outflow of separated liquid, the control system comprising:
a control valve for operable connection to one of the ports, the control valve having an actuator that in response to a control gas, changes a position of the control valve;
a control gas line leading to the control valve for supplying the control gas to the actuator;
a sensor for connection to the separator and sensing a parameter of the separator;
a sensor valve connected into the control gas line and to the sensor for providing the control gas to the actuator in response to the parameter sensed; and
a filter in the control gas line upstream of the sensor valve for removing liquid from the control gas, the filter having an upstream end and a downstream end and being oriented with the upstream end at a lower elevation than the downstream end for causing liquid separated from the control gas to flow back into the control gas line upstream of the filter.

2. The control system according to claim 1, further comprising:
a tubular housing connected into the control gas line;
a pair of plates located in the housing with the filter located therebetween, each of the plates having at least one aperture for the passage of the control gas.

3. The control system according to claim 2, wherein the filter comprises a strip of mesh material rolled up about an axis of the tubular housing.

4. The control system according to claim 1, further comprising:
a tubular housing containing the mesh filter and having a threaded outlet and a threaded inlet, the outlet and the inlet having inner diameters that are the same as an inner diameter of the housing.

5. The control system according to claim 1, wherein the sensor comprises a float valve for determining when separated liquid in the separator reaches a selected level.

6. The control system according to claim 1, further comprising a pressure regulator connected to the control gas line downstream of the filter for reducing pressure of the control gas in the control gas line.

7. The control system according to claim 1, further comprising a control gas separator in the control gas line downstream from the filter for removing residual amounts of liquid that may be present in the control gas.

8. A gas processor, comprising:
a separator having a main inlet for receiving a liquid/gas mixture, a main outlet line for the outflow of separated gas, and a liquid drain line for draining collected liquid from the separator;
a drain valve connected to the drain line, the drain valve having an actuator operable in response to pressure from a control gas for opening the drain valve;
a control gas line leading from a point downstream of the main inlet of the separator to the control valve for supplying the control gas to the actuator;
a pressure regulator in the control gas line for reducing the pressure of the control gas in the control gas line to a level below the pressure in the main outlet line;
a float valve connected into the control gas line and to the separator for providing the control gas to the actuator in response to detecting a selected level of liquid in the separator; and
a filter assembly in the control gas line upstream of the pressure regulator, the filter assembly having a tubular housing containing a mesh filter for removing liquid from the control gas, the housing having an inlet located below an outlet for causing liquid trapped by the mesh filter to drain back through the inlet into the control gas line upstream of the filter assembly.

9. The processor according to claim 8, wherein the filter assembly further comprises:
a pair of plates located in the housing with the mesh filter located therebetween, each of the plates having at least one aperture for the passage of the control gas.

10. The control system according to claim 8, wherein the mesh filter comprises a strip of mesh material rolled up about an axis of the housing.

11. The control system according to claim 8, wherein the housing has a threaded outlet and a threaded inlet for connection into the control gas line, the outlet and the inlet having inner diameters that are the same as an inner diameter of the housing.

12. The control system according to claim 8, further comprising a control gas separator in the control gas line downstream from the filter assembly for removing residual amounts of liquid that may be present in the control gas.

13. A method of controlling a gas/liquid separator having a first port for receiving a liquid/gas mixture, a second port for the outflow of separated gas and a third port for the outflow of separated liquid, comprising:
(a) connecting a control valve to one of the ports, the control valve having a pressure activated actuator;
(b) connecting a control gas line to the control valve;
(c) connecting a sensor valve to the separator and into the control gas line; and
(d) connecting a filter in the control gas line upstream of the sensor valve, the filter having an upstream end and a downstream end and being oriented with the upstream end at a lower elevation than the downstream end;
(e) when the sensor valve senses a selected parameter of the separator, flowing control gas through the filter to the actuator and changing a position of the control valve in response thereto; and
(f) with the filter separating any liquid in the control gas and draining the separated liquid out the upstream end of the filter into the control gas line.

14. The method according to claim 14, wherein step (b) comprises connecting an upstream end of the control gas line to a point downstream of the first port of the gas/liquid separator.

15. The method according to claim 13, wherein step (d) comprises placing mesh filter material within a tubular housing and connecting the housing into the control gas line.

16. The method according to claim 13, wherein step (e) comprises sensing a level of separated liquid in the gas/liquid separator.

17. The method according to claim 16, wherein step (e) further comprises opening the control valve to allow separated liquid in the gas/liquid separator to drain from the separator.

18. The method according to claim 13, further comprising reducing pressure of the control gas in the control gas line downstream of the filter.

19. The method according to claim 13, wherein step (f) comprises draining the separated liquid from the filter into a main outlet flowline of the gas/liquid separator.

20. The method according to claim 13, wherein step (f) comprises draining the separated liquid from the filter into the gas/liquid separator.
